(19) United States
(12) Patent Application Publication
(10) Pub. No.: US 2012/0170445 A1
(43) Pub. Date: Jul. 5, 2012

(54) EFFICIENT APPLICATION-LAYER AUTOMATIC REPEAT REQUEST RETRANSMISSION METHOD FOR RELIABLE REAL-TIME DATA STREAMING IN NETWORKS

(75) Inventors: Ramkumar Perumanam, Edison, NJ (US); Ishan Uday Mandrekar, Monmouth Junction, NJ (US); Mingquan Wu, Princeton Juntion, NJ (US); Hang Liu, Yardley, PA (US); Saurabh Mathur, Monmouth County, NJ (US)

(73) Assignee: Thomson Licensing, Boulogne-Billancourt (FR)

(21) Appl. No.: 13/395,796

(22) PCT Filed: Oct. 7, 2009
(86) PCT No.: PCT/US09/05499

§ 371 Date: Mar. 13, 2012

(51) Int. Cl. H04L 12/24

(52) U.S. Cl. 370/216

(57) ABSTRACT

A method and apparatus are described including buffering data to be transmitted, transmitting data retrieved from a buffer via a datagram protocol, receiving a request for retransmission of data, determining if the requested data is in the buffer and retransmitting the requested data via a protocol that provides end-to-end acknowledgement of data and error recovery.

### FIELD OF THE INVENTION

The present application relates to networks in general and in particular, to an application-layer method for automatic repeat request (ARQ) retransmission of real-time data streaming.

### BACKGROUND OF THE INVENTION

In multicast or broadcast applications, data are transmitted from a server to multiple receivers over wired and/or wireless networks. A multicast system as used herein is a system in which a server transmits the same data to multiple receivers simultaneously, where the receivers form a subset of all the receivers up to and including all of the receivers. A broadcast system is a system in which a server transmits the same data to all of the receivers simultaneously. That is, a multicast system by definition can include a broadcast system.

Data is usually formatted into packets and or frames for transmission. That is, packets and frames are data formatting schemes. As used herein data can be formatted into any convenient format for transmission including packets and/or frames.

Video transmission or distribution in wireless networks normally involves packet loss caused by channel error conditions such as interference, channel fading, collision, etc. When such channel error conditions occur, the wireless link layer of the protocol stack tries to retransmit packets for a fixed number of times within a fixed time period. If these retransmissions are not successful, the packets are dropped by the wireless link layer. Internet Protocol (IP) network based video transmission typically delivers video packets to the destination (receiver) using Real-time Transport Protocol (RTP) protocol that, in turn, uses either a reliable Transmission Control Protocol (TCP) transport protocol or a less reliable User Datagram Protocol (UDP) transport protocol. When the less reliable UDP protocol is used, the protocol does not provide a means to detect out of order packets or recover lost packets and leaves the responsibility to the application to recover packet delivery errors. In contrast, when TCP protocol is used, end to end acknowledgements are provided so that the protocol tries to send and/or recover media (audio, video, multimedia, . . . ) packets (data) strictly in the order in which the packets are to be handled by the application. When packet errors are detected, TCP's sliding window mechanism activates the flow control and reduces the packet transmission rate. TCP keeps retransmitting the lost packets until they are recovered. Since the video transmission has to occur in real time and has user viewing experience associated with the receipt and rendering of the data, there is a latency or time constraint within which the packets have to be delivered or recovered so as to not impact the end user's viewing experience. Therefore, it is apparent that packet errors have to be recovered within a limited time otherwise the data is not useful to the end user. With TCP there is no way for an application to control the packet recovery based on a time constraint. Using TCP as the transport protocol for wireless networks could lead to a poor user viewing experience. Furthermore, TCP requires positive acknowledgement for all the transmitted data packets. The TCP uplink acknowledgements (from data receiver to data transmitter (sender)) will compete for the wireless bandwidth with downlink data traffic (from transmitter (sender) to receiver). If collisions occur among downlink and uplink transmissions, the collisions could lead to further throughput reduction.

In one prior art scheme, a block-based application-layer Forward Error Correction (FEC) mechanism was proposed. Application-layer FEC mechanism works on packet levels such as RTP or UDP packets. It is different from the physical layer FEC and applies FEC codes across multiple data packets to generate redundant parity packets on the server (transmitter, sender) side. The transmitter sends out both data packets and FEC packets to the target receivers. On the receiver side, the FEC decoder tries to reconstruct missing packets by using received data packets and FEC packets. For this scheme to be efficient it is essential that it adapts to time varying channel conditions. However, the challenge is how to predict the channel conditions in advance and to adapt the FEC code to the varying channel conditions efficiently and reliably. If underestimation occurs, lost packets cannot be recovered. However, if overestimation occurs, bandwidth is wasted. Therefore, this method is difficult to fine tune without compromising either reliability or bandwidth.

In other prior art schemes, variations of Automatic Repeat Request (ARQ) have been proposed for packet loss recovery. Automatic Repeat Request is an error control method for data transmission. In one approach, a positive acknowledgment with timeouts is used in the ARQ scheme to achieve reliable data transmission. A positive acknowledgment (ACK) is sent by the receiver to the transmitter to indicate that the receiver has correctly received a data frame or packet. The transmitter also maintains a timeout timer that is a reasonable point in time after the transmitter sends the data frame or packet. If the transmitter does not receive an acknowledgment before the timeout, the transmitter usually re-transmits the data frame or packet until the transmitter receives an acknowledgment or exceeds a predefined number of re-transmissions. In this approach, the amount of acknowledgement data packet or frame traffic from the receiver and transmitter is high when the packet loss rate is low (most of data packets/frames are correctly received and need to be acknowledged). The acknowledgement data packets or frames will compete for the wireless bandwidth with data packets or frames. In addition, collisions may occur between the transmissions of data packets and acknowledgement packets.

In yet another prior art approach, the negative acknowledgement (NACK) is sent by the receiver to the transmitter to indicate that it has not correctly received a data frame or packet. Once the transmitter receives the NACK, the transmitter retransmits the lost data packet or frame to the receiver. The amount of NACK traffic from the receiver and transmitter is low when the packet loss rate is low, leading a more efficient utilization of network resources including bandwidth. However, the NACK data packets or frames themselves may be lost. If this occurs, the transmitter would not retransmit the lost data packets or frames, causing low reliability.

It would be advantageous to have an efficient method to provide reliability to UDP based video transmission by requesting only the lost packets from the original transmitter (sender) and trying to recover packets within a time constraint acceptable to the application thus enhancing the reliability and system throughput, and improving the overall user viewing experience of real-time applications.

### SUMMARY OF THE INVENTION

This present invention is directed to a method at the transport or application layer to increase the reliability of real time video streaming in networks. Video streaming is used here as a specific example of real-time data streaming. Real-time data streaming may include any type of data including audio, video, multimedia or any combination thereof. The method of the present invention is not specific to wireless networks or wireless local area networks. It can be deployed for wired line or wireless networks. Wireless networks are used as an exemplary deployment. The method of the present invention provides an efficient means to recover lost packets in networks that are characterized by packet losses caused by various channel errors, thus enhancing the reliability and quality of video transmissions. The method of the present invention provides an efficient method to provide reliability to UDP based video transmission by requesting only the lost packets from the original transmitter (sender) and trying to recover packets within a time constraint acceptable to the application thus enhancing the reliability and system throughput, and improving the overall user viewing experience of real-time applications.

The present invention provides a method, which combines the advantages of a positive ACK with timeouts and negative acknowledgements. The NACK is used for initial transmissions. But the NACK packets or frames and the retransmitted data packets or frames are sent using an ACK with timeout on a separate TCP channel. The present invention uses TCP to provide a reliable error recovery path and also take the application's real-time constraints into consideration by enforcing an upper bound on the recovery time window.

A method and apparatus are described including buffering data to be transmitted, transmitting data retrieved from a buffer via a datagram protocol, receiving a request for retransmission of data, determining if the requested data is in the buffer and retransmitting the requested data via a protocol that provides end-to-end acknowledgement of data and error recovery.

### BRIEF DESCRIPTION OF THE DRAWINGS

The present invention is best understood from the following detailed description when read in conjunction with the accompanying drawings. The drawings include the following figures briefly described below:

FIG. 1A is a flowchart of the method of the present invention as practiced by the server in initial transmission of data to a client device.

FIG. 1B is a flowchart of the method of the present invention as practiced by the server in retransmission of corrupted data.

FIG. 2A is a flowchart of the method of the present invention as practiced by a client in initial reception of data.

FIG. 2B is a flowchart of the method of the present invention as practiced by a client in receiving retransmitted data.

FIG. 2C is a flowchart of the method of the present invention as practiced by a client in rendering data.

FIG. 3 is a protocol stack.

FIG. 4A shows the common header of an exemplary message used to request retransmission and reply to a retransmission request.

FIG. 4B shows an exemplary format of a retransmitted packet of data.

FIG. 4C shows an exemplary format of a retransmission negative acknowledgement (NACK).

FIG. 4D shows an alternative exemplary format of a retransmission negative acknowledgement (NACK).

FIG. 5 is a schematic diagram of an exemplary embodiment of the server in accordance with the principles of the present invention.

FIG. 6 is a schematic diagram of an exemplary embodiment of a client device in accordance with the principles of the present invention.

### DETAILED DESCRIPTION OF THE PREFERRED EMBODIMENTS

Video transmission or distribution in wireless networks typically use RTP, motion picture expert group 2 transport stream (MPEG2TS) over UDP and could be distributed from a single source to a single destination (unicast mode) or from a single source to multiple destinations (multicast mode). Since channel conditions vary in wireless networks, packet transmissions, when the channel conditions are not good, result in dropped packets if the link layer error recovery is not successful. In these situations there is a gap in the packet sequence resulting in poor viewing quality for the end user. The present invention provides an efficient application-layer based retransmission scheme, called reliable media protocol (RMP) herein, to recover packet losses to aid in reliable real-time streaming applications.

In the reliable media protocol (RMP) method of the present invention, the regular unicast and multicast data or packet transmissions make use of UDP. Apart from this, an additional reliable TCP-based control channel is established between the source (transmitter, sender) and the destination (receiver, sink) to request and receive the retransmission of lost packets. For this mechanism to work properly, the transmitter (sender) maintains a cache of the most recent packets that were sent to its receivers. One or more receivers receive the data packets from the transmitter and detect sequence gaps in the received data packets using the sequence number field present in the RTP or MPEG transport stream (TS) header. If the receiver detects a sequence gap, the receiver sends a request on the TCP-based control channel for selective retransmission of the missing data packets. When the transmitter receives a retransmission request from one or more of its receivers, it looks in its local cache of most recent packets. If the requested packet(s) is/are found in the local cache, the sender retransmits in unicast a copy of the packet to the receiver on the TCP-based control channel. If the requested packet was not found in its local cache, the sender continues servicing the rest of the retransmission requests. The receiver maintains a delivery queue (buffer) to hold all of the received data packets from both data and control channels and reorders the retransmitted packet into the correct sequence (position) within this queue and delivers the packets to the application in the proper order at the correct time. The receiver maintains a configurable time window to wait for any retransmissions rather than waiting forever so that the packet delay and delay jitter can be kept within the application bounds. This implies that the receiver passes the rest of the received packets from the delivery queue to the application if some of the retransmission replies for the lost packets are not received in time. If some of the retransmitted packets are received beyond the acceptable recovery time window they are discarded by the receiver. It should be noted that the video application can tolerate some data packet loss using error concealment technology in video decoding.

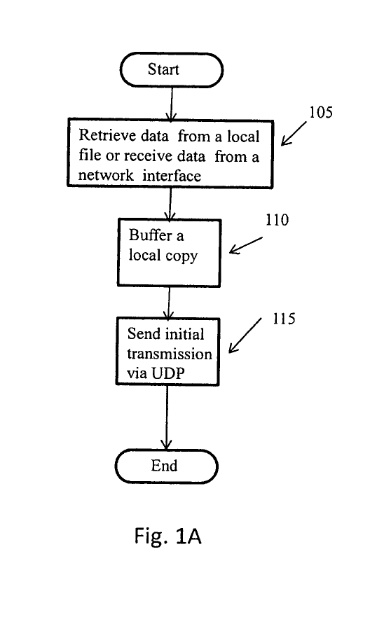

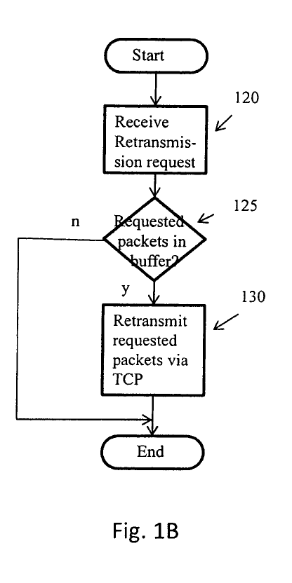

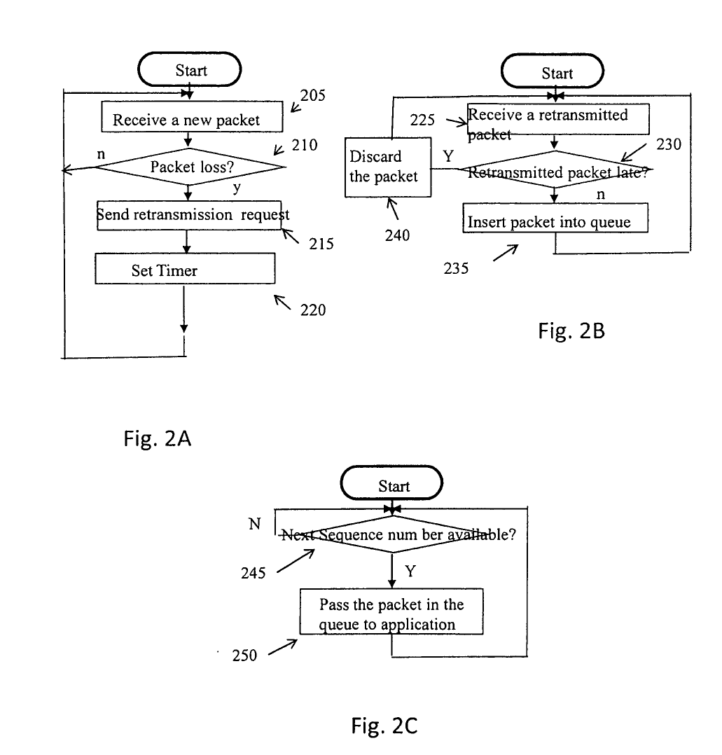

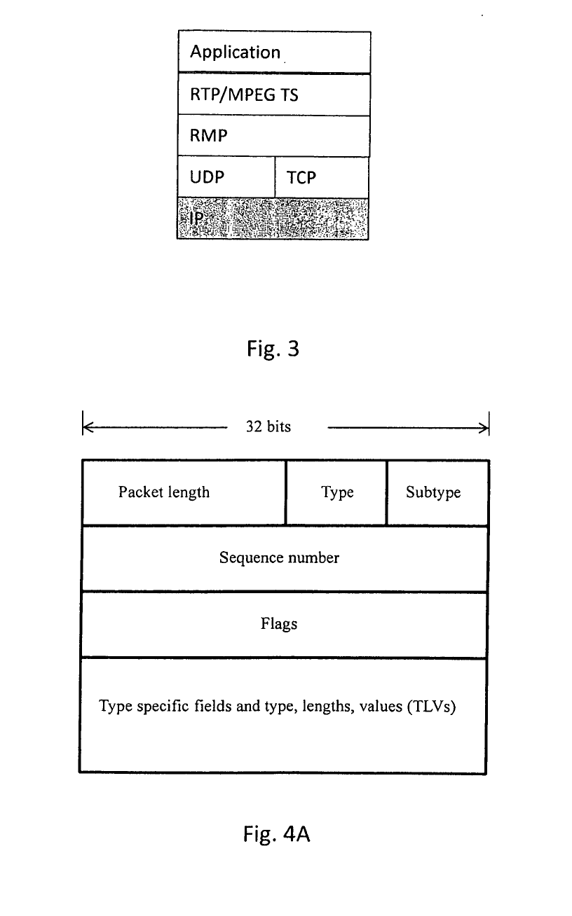

The flowcharts for the sender side and receiver side operations in accordance with the present invention are depicted in FIGS. 1A, 1B and 2A, 2B and 2C. FIG. 3 shows the protocol stack in accordance with the present invention. The reliable media protocol (RMP) scheme in the present invention operates between the real-time application/RTP/MPEG TS and UDP/TCP/IP.

Referring again to FIG. 1A, at 105 the transmitter (server, sender) receives the data to be transmitted from a local file (not shown) or from another network interface module (not shown) in communication with, for example, a content server or content distribution system (not shown). At 110 the transmitter buffers a copy of the data to be transmitted in a buffer (local cache, memory) and at 115 forwards the data to be transmitted to the UDP/IP module for transmission via the network interface module.

Referring again to FIG. 1B, at 120 the server (transmitter of the original data) receives a retransmission request from the receiver when the receiver determined that packets were missing (lost, destroyed, damaged). The server receives the retransmission request via the TCP/IP module which received the retransmission request via the network interface module. At 125 the server determines if the requested data packets (to be retransmitted) are in the buffer. If the data packets are in the buffer then at 130 the server retrieves the requested data packets from the buffer and forwards them to the TCP/IP module for retransmission via the network interface module. If the data packets are not in the buffer then the server is not able to retransmit the requested data packets.

Referring again to FIG. 2A, at 205 the client device receives new data packet(s). The retransmitted data packet(s) are received from the TCP/IP module via the network interface module. At 210 the client determines if the new data packet(s) is/are lost (destroyed, damaged). Herein, the term “corrupted data” includes any data that was lost, destroyed or damaged. If the new data packet(s) is/are lost (destroyed, damaged) then at 215 the client generates and sends a retransmission request to the server via the TCP/IP module which forwards the retransmission request to the network interface module for transmission. At 220 the client sets a timer to constrain the time that the client waits for the retransmitted data packet(s). If the received data is not corrupted than it is inserted into a queue for later rendering.

Referring again to FIG. 2B, at 225, the client receives the retransmitted data packet(s) from the TCP/IP module which received the retransmitted data packet(s) from the network interface module. At 230 the client determines if the retransmitted data packet(s) is/are too late by inspecting the timer (set in FIG. 2A). If the retransmitted data packet(s) is/are not too late then at 235 the retransmitted data packet(s) is/are inserted into the queue for rendering in the proper order. If the retransmitted data packet(s) is/are too late then at 240 the client discards the retransmitted data packet(s). Referring again to FIG. 2C, at 245 the client checks the sequence number to determine if the data packet with the next sequence number is available. If the data packet with the next sequence number is available then at 250 the data packet is inserted into the queue for rendering. If the data packet with the next sequence number is not available then the client continues to inspect data packets until it finds a data packet to insert into the queue for rendering. Error concealment may also be available to hide or disguise some errors or missing data packet(s).

Referring again to FIG. 3, a protocol stack is shown. The protocol stack shows the application layer at the top of the protocol stack. Immediately below the application layer is RTP/MPEG TS layer. Immediately below the RTP/MPEG TS layer is the RMP layer of the present invention. The RMP layer is supported by the TCP and UDP layers which are, in turn, supported by the internet protocol (IP) layer. The TCP, UDP and IP layers are typically considered layers 3 and 4 of an ISO protocol stack. Layers 3 and 4 are typically supported by a link layer (layer 2, which may be for example, a media access control (MAC) layer) and a physical layer (layer 1).

The RMP method of the present invention may be implemented in a flexible software library, hardware, firmware, any computer or processor, an application specific integrated circuit (ASIC), a reduced instruction set computer (RISC), a filed programmable gate array (FPGA) or an combination thereof. The RMP method of the present invention uses socket-like user-space APIs and underlying transport means for easy integration with streaming server and player applications. The RMP method of the present invention is transparent to the streaming applications that it supports. The UDP data channel and the TCP control channel are internally maintained. The RMP method of the present invention is extensible to support other error recovery schemes such as FEC and hybrid ARQ.

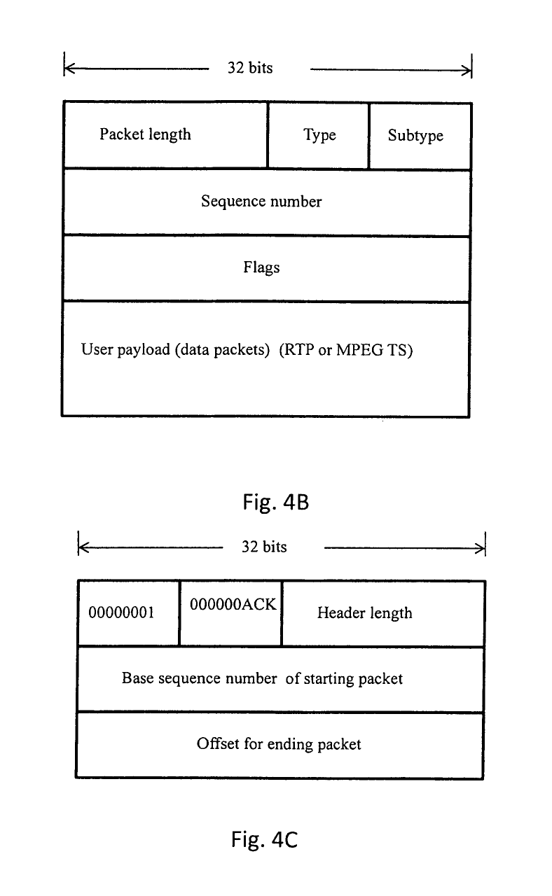

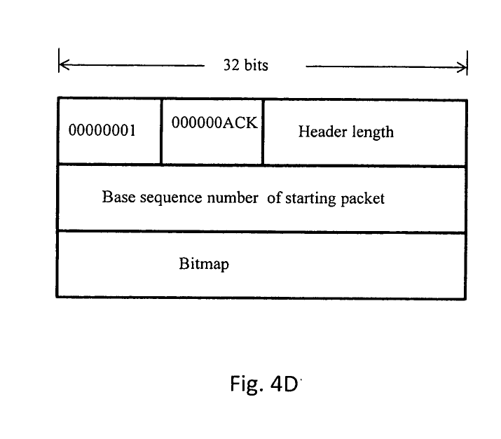

The exemplary format of the messages exchanged for retransmission request and reply is shown in FIGS. 4A and 4B. All the retransmission request/reply messages have a common header whose format is shown in FIG. 4A. FIG. 4B shows the format of a retransmitted packet, which contains the packet length field, packet type field and packet subtype field, the flags, and payload (retransmitted data). The payload is the data packet (or frame) that was lost in the previous transmission. As shown in FIG. 4C, the retransmission request/NACK control packet contains the packet length field, packet type and subtype field, the flags, starting sequence number and end sequence number. The starting sequence number and end sequence number fields indicate the sequence range of the packets that the receiver requests to be retransmitted. In an alternative embodiment as shown in FIG. 4D, the retransmission request/NACK control packet contains the packet length field, packet type and subtype field, the flags, the base sequence number and bitmap. The base sequence number and the bitmap indicate the sequence of the packets that the receiver requests to be retransmitted.

In the RMP scheme of the present invention described above, no alterations are made to the packets sent on the data channel. Thus, backward compatibility is maintained. Also the RMP scheme of the present invention makes efficient use of the bandwidth since only the lost media packets are requested and retransmitted on the control channel with low overhead. The lost packet requests serve as NACKs (Negative Acknowledgements) and also provide feedback to the sender. It can provide high reliability under widely different channel conditions because a lost packet can be retransmitted multiple times within the recovery time window. Also the RMP scheme of the present invention enforces the application's latency constraint by having a maximum wait time, i.e. recovery window, for retransmissions and thus operates on the best effort delivery model within the given time constraint.

Note that the above embodiment is explained using video transmission. The present invention can also be applied to transmission of audio and other real-time multimedia streaming applications.

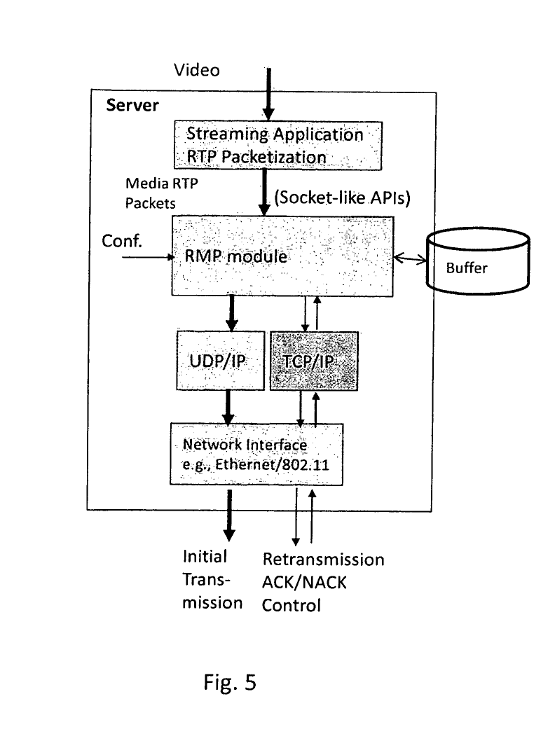

FIG. 5 shows the schematic of an exemplary server implementation. The server includes of a streaming application module, a buffer (memory), a reliable media protocol (RMP) module, a UDP/IP module, TCP/IP module and a network interface module. The streaming application module obtains real-time data from a local file or a network interface module. The network interface module is the network card present in the computer that transmits/receives packets from the network. A single network card does the bidirectional functions of transmission and reception. Examples of network interface modules are Ethernet cards, IEEE 802.11/WiFi cards that connect to the computer network. The streaming application module packetizes the real-time data if the data is not packetized. The streaming application module passes the real-time data packets (media RTP packets) to the RMP module. The RMP module provides a socket-like application protocol interface (API) for data passing and integration with the application. The RMP module also handles reliable transport of data packets. For initial transmission, the RMP module uses a UDP/IP data channel and sends the data packets to the receiver(s) through the network interface, which may be, for example, an Ethernet interface or an IEEE 802.11 interface. The RMP module also caches a local copy of the transmitted packets in the buffer. It receives the retransmission request/negative acknowledgement from the receiver through the TCP/IP control channel. The RMP module retransmits the requested packets to the receiver using the TCP/IP control channel if the requested packets are in the buffer. The box labeled “Conf” is a “Configuration Interface” to the RMP module. RMP module can be configured at the time of initialization to set parameters such as cache size, maximum time to wait for packet recovery etc.

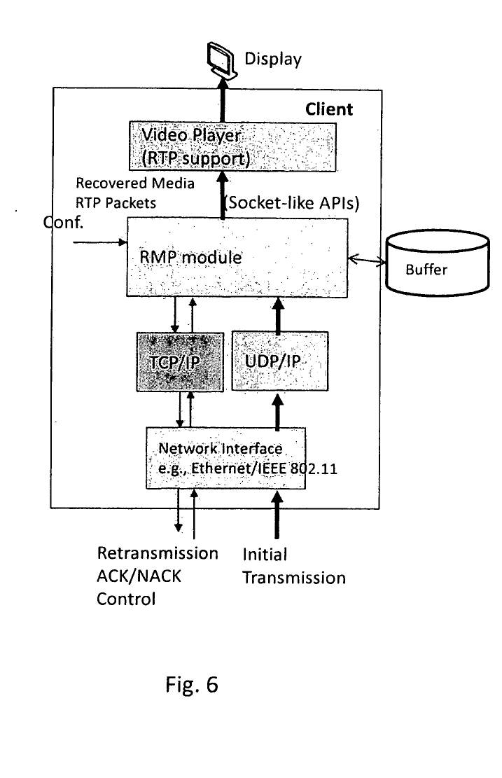

FIG. 6 shows the schematic of an exemplary implementation of a client device. The client includes a player/streaming application module, a display/speaker module, a buffer (memory), a reliable media protocol (RMP) module, a UDP/IP module, a TCP/IP module and a network interface. The network interface may be, for example, an Ethernet interface or an IEEE 802.11 interface. The network interface receives all incoming messages. The messages arrive on different sockets/addresses. The network interface can thus, determine where to forward the received messages. New incoming data packets are forwarded to the UDP/IP interface by the network interface module. Requests for retransmission of data packets and the retransmitted data packets are forwarded to the TCP/IP module by the RMP module. The RMP module determines if any of the received data packets have been corrupted and makes use of both UDP/IP and TCP/IP to orchestrate the packet recovery. The RMP module generates a retransmission request for any corrupted data packets and forwards the retransmission request to the TCP/IP module for transmission over the network by the network interface. The RMP module also stores the received packets in the local buffer for reordering. Once the retransmitted packets are received from the TCP control channel via the TCP/IP module, the RMP module the packets in the correct order. The RMP maintains a queue that is sorted on the sequence number and will reorder and insert packets into this buffer area/queue. When the recovery window expires, the RMP module delivers the packets to the player/streaming application. The RMP module provides a socket-like application protocol interface (API) for data passing and integration with the application. Note that some packets may not be recovered by the timeout of recovery window. Data packets arriving after the expiration of the recovery window are discarded. The streaming/player application depacketizes and/or decodes the data and passes the data to the display/speaker. The incoming packets are stored in the RMP “Buffer area” and will be handed over to the application for rendering (display) whenever an application requests a packet. The box labeled “Conf” is a “Configuration Interface” to the RMP module. RMP module can be configured at the time of initialization to set parameters such as cache size, maximum time to wait for packet recovery etc.

Though the above scheme of the present invention has been described with respect to wireless networks, the scheme could be used in any kind of network that involves packet losses.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for operating a server, said method comprising:
buffering data to be transmitted in a buffer;
transmitting data retrieved from the buffer via a datagram protocol, to a client device;
receiving a request, from said client device, for retransmission of data;
determining if said requested data is in said buffer; and
retransmitting said requested data, to said client device, via a protocol that provides end-to-end acknowledgement of data and error recovery.

2. The method according to claim 1, wherein said datagram protocol is user datagram protocol.

3. The method according to claim 1, wherein said buffered data is one of retrieved from a local file and received via a network interface.

4. The method according to claim 1, wherein said transmitted data is one of multicast and unicast and wherein said retransmitted data is unicast.

5. A method for operating a client device, said method comprising:
receiving data from a server;
determining if said received data includes any corrupted data;
inserting said received data into a queue responsive to said determination;
transmitting, to said server, a request for retransmission of said corrupted data;
receiving said retransmitted data from said server;
determining if said retransmitted data was timely received; and
one of inserting said received retransmitted data in said queue and discarding said received retransmitted data.

6. The method according to claim 5, wherein said determining act is performed using a timer.

7. The method according to claim 5, further comprising rendering said queued data.

8. An apparatus for operating a server, comprising:
means for buffering data to be transmitted;
means for transmitting data retrieved from a buffer via a datagram protocol, to a client device;
means for receiving a request for retransmission of data, from said client device;
means for determining if said requested data is in said buffer; and
means for retransmitting, to said client device, said requested data via a protocol that provides end-to-end acknowledgement of data and error recovery.

9. The apparatus according to claim 8, wherein said datagram protocol is user datagram protocol.

10. The apparatus according to claim 8, wherein said buffered data is one of retrieved from a local file and received via a network interface.

11. The apparatus according to claim 8, wherein said transmitted data is one of multicast and unicast and wherein said retransmitted data is unicast.

12. An apparatus for operating a client device, comprising:
means for receiving data, from a server;
means for determining if said received data includes any corrupted data;
means for inserting said received data into a queue responsive to said determination;
means for transmitting a request for retransmission of said corrupted data, to said server;
means for receiving said retransmitted data, from said server;
means for determining if said retransmitted data was timely received; and
means for one of inserting said received retransmitted data in said queue and discarding said received retransmitted data.

13. The apparatus according to claim 12, wherein said determining act is performed using a timer.

14. The apparatus according to claim 12, further comprising means for rendering said queued data.
